(19) United States
(12) Patent Application Publication
(10) Pub. No.: US 2015/0347071 A1
(43) Pub. Date: Dec. 3, 2015

(54) PRINT MANAGEMENT APPARATUS, IMAGE FORMING SYSTEM, AND NON-TRANSITORY COMPUTER READABLE MEDIUM

(71) Applicant: FUJI XEROX CO., LTD., Tokyo (JP)

(72) Inventors: Takeshi NAMINOUE, Kanagawa (JP); Naoya TAKAYAMA, Kanagawa (JP)

(21) Appl. No.: 14/553,174

(22) Filed: Nov. 25, 2014

(30) Foreign Application Priority Data
May 28, 2014 (JP) 2014-110686

(51) Int. Cl. G06F 3/12; G06K 15/00

(52) U.S. Cl. CPC G06F 3/1275; G06K 15/4065; G06K 15/408; G06F 3/1205; G06F 3/1234; G06F 3/1259; G06F 3/1296

(57) ABSTRACT

A print management apparatus includes an acquisition section, a detecting section, an error job generation section, and a print job management section. The acquisition section acquires print information on plural print jobs to be performed by an image forming apparatus. The detecting section detects types of recording materials to be used in units of the plural print jobs on the basis of the acquired print information. The error job generation section generates a first error job including information that is not printable by the image forming apparatus when the detected types of the recording materials are different between successive print jobs. The print job management section manages the plural print jobs, and inserts the first error job between the successive print jobs when the first error job is generated.

### CROSS-REFERENCE TO RELATED APPLICATIONS

This application is based on and claims priority under 35 USC 119 from Japanese Patent Application No. 2014-110686 filed May 28, 2014.

### BACKGROUND

(i) Technical Field

The present invention relates to a print management apparatus, an image forming system, and a non-transitory computer readable medium.

(ii) Related Art

<Operation of Print Server>

Operation of a print server 100 will be described. First, a problem with the print server 100 according to the related art will be described.

FIG. 4 illustrates an example of the functional configuration and operation of the print server 100 according to the related art.

The print server 100 according to the related art illustrated in FIG. 4 is different from a print server 100 according to an exemplary embodiment illustrated in FIG. 2 in being not provided with a detecting section 140 and an error job generation section 150.

In FIG. 4, print jobs 1 to 6 are acquired from a host server 300 and accumulated in an accumulating section 120, and further a print job management section 130 manages the print jobs 1 to 6 so that printing is performed in this order.

In this event, paper with a paper size of A4 and a paper name of “a” is used for the print job 1. Similarly, paper with a paper size of A4 and a paper name of “b” is used for the print job 2. Paper with a paper size of B4 and a paper name of “c” is used for the print job 3. Further, paper with a paper size of B4 and a paper name of “c” is used for the print job 4. Paper with a paper size of B4 and a paper name of “d” is used for the print job 5. Paper with a paper size of A4 and a paper name of “e” is used for the print job 6.

That is, even pieces of paper of the same paper size may have different paper names. In this case, pieces of paper with different paper names have different paper types. For example, the paper types are different from each other in accordance with the difference in paper thickness (such as thin paper and thick paper), the difference in paper color (such as white paper and color paper), the difference between plain paper and pre-printed paper on which index characters, ruled lines, etc. are printed in advance, or the difference in content printed in advance on the pre-printed paper such as characters, lines, etc.

Then, the output section 160 outputs to an image forming apparatus 200 the print data for the print jobs 1 to 6 in this order.

In this event, in the case where the image forming apparatus 200 is of a type in which print data are printed while receiving the print data, and if there is a difference in type of paper to be used for successive print jobs, the image forming apparatus 200 first detects such a difference. Then, before print data for the latter one of the successive print jobs are output from the print server 100, output of the print data for the latter print job is stopped. Consequently, printing by the image forming apparatus 200 may be stopped once, which provides a user with a time to change the paper.

In the case where the image forming apparatus 200 is of a type in which print data for plural print jobs are accumulated and then printed, however, the image forming apparatus 200 performs printing after the print data for the plural print jobs are output from the print server 100. In this event, the following problem is caused.

In the image forming apparatus 200, after the print data for the print jobs 1 to 6 are accumulated once, printing processes for the print jobs 1 to 6 are performed in this order. In this event, in the image forming apparatus 200, in the case where the paper sizes of pieces of paper to be used for successive print jobs are different from each other when the former print job is finished and the latter print job is to be executed, printing is stopped. Then, an error message that indicates the difference in paper size and prompts a change of paper is output. In the case where pieces of paper to be used are of different types but of the same paper size, meanwhile, the image forming apparatus 200 executes the print job without outputting an error message. Therefore, printing may be performed on unintended paper.

In the example of FIG. 4, when the print job 2 is performed after the print job 1, the types of pieces of paper to be used for the print jobs are different from each other because paper with a paper name of “a” is used for the print job 1 and paper with a paper name of “b” is used for the print job 2. Because the sizes of pieces of paper to be used for the print jobs are both A4 and the same as each other, however, the print job 2 is executed without any change. As a result, printing for the print job 2 is performed on paper with a paper name of “a”.

Similarly, when the print job 5 is performed after the print job 4, printing for the print job 5 should be performed on paper with a paper name of “d”. Since the sizes of pieces of paper to be used for the print jobs are both B4 and the same as each other, however, the print job 5 is executed without any change. As a result, printing for the print job 5 is performed on paper with a paper name of “c”, which is used for the print job 4.

In the case where the print job 3 is performed after the print job 2, and in the case where the print job 6 is performed after the print job 5, the sizes of pieces of paper to be used for the successive print jobs are different from each other. Therefore, printing is stopped, and the image forming apparatus 200 outputs an error message that prompts a change of paper. Therefore, such a problem is not caused.

When the print job 4 is performed after the print job 3, further, the types of pieces of paper to be used for the successive print jobs are the same as each other. Therefore, the problem is also not caused.

### SUMMARY

According to an aspect of the present invention, there is provided a print management apparatus including: an acquisition section that acquires print information on plural print jobs to be performed by an image forming apparatus; a detecting section that detects types of recording materials to be used in units of the plural print jobs on the basis of the acquired print information; an error job generation section that generates a first error job including information that is not printable by the image forming apparatus when the detected types of the recording materials are different between successive print jobs; and a print job management section that manages the plural print jobs and that inserts the first error job between the successive print jobs when the first error job is generated.

### BRIEF DESCRIPTION OF THE DRAWINGS

An exemplary embodiment of the present invention will be described in detail based on the following figures, wherein:

FIG. 1 illustrates an example of the configuration of an image forming system according to an exemplary embodiment;

FIG. 2 illustrates an example of the functional configuration of a print server;

FIG. 3 illustrates an example of the hardware configuration of the print server;

FIG. 4 illustrates an example of the functional configuration and operation of a print server according to the related art;

FIG. 5 illustrates an example of the functional configuration and operation of the print server according to the exemplary embodiment, illustrated in accordance with FIG. 4;

FIG. 6 illustrates the data format of print data for print jobs and error jobs;

FIG. 7 illustrates a first example of error messages output from an image forming apparatus;

FIGS. 8A to 8C illustrate a second example of error messages output from the image forming apparatus; and

FIG. 9 is a flowchart illustrating operation of the print server.

### DETAILED DESCRIPTION

An exemplary embodiment of the present invention will be described in detail below with reference to the accompanying drawings.

### <System Configuration>

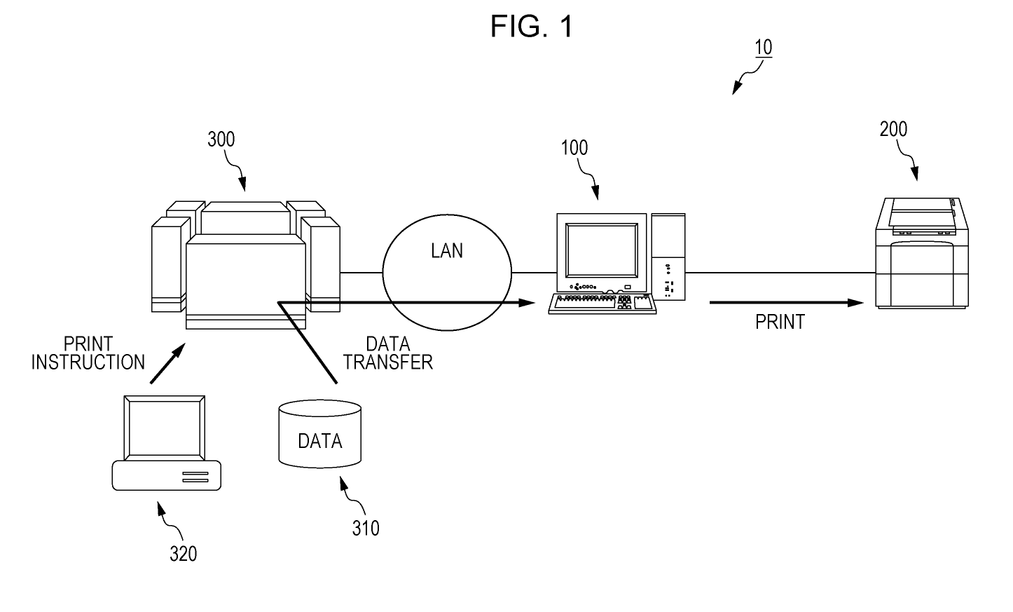

FIG. 1 illustrates an example of the configuration of an image forming system according to an exemplary embodiment.

An image forming system 10 illustrated in FIG. 1 includes a print server 100 and an image forming apparatus 200. The print server 100 manages a print job, which is a process based on a print instruction (output instruction). The image forming apparatus 200 executes a printing process (image forming process) under control by the print server 100. The print server 100 and the image forming apparatus 200 are connected to each other directly or via a network or the like. The print server 100 is also connected to a host server 300 via a local area network (LAN).

The print server 100 is an example of a print management apparatus that manages printing performed by the image forming apparatus 200, and is implemented by a personal computer or the like provided with a network function, for example. The print server 100 receives a print instruction and print data (print information, output data) from the host server 300, and accumulates (spools) such data. Then, the print server 100 transmits the accumulated print data to the image forming apparatus 200, and causes the image forming apparatus 200 to execute a print process. The specific functional configuration of the print server 100 will be described in detail later.

The image forming apparatus 200 acquires print data from the print server 100, and prints and outputs the print data by forming an image on a recording material such as paper using an image forming material on the basis of the acquired print data. In the exemplary embodiment, the mechanism that forms an image on paper is not specifically limited, and a variety of the existing methods such as an electrophotographic system in which toner is used as the image forming material and an inkjet system in which ink is used as the image forming material may be used.

The host server 300 is implemented by a computer provided with a network function, for example, and includes a storage device 310 that holds print data. Then, upon receiving a print instruction, the host server 300 reads print data specified by the print instruction from the storage device 310, and transmits the print data to the print server 100. The print instruction is input from a terminal device 320 connected to the host server 300, for example. The terminal device 320 is implemented by a personal computer or the like provided with an input device such as a keyboard, for example.

<Functional Configuration of Print Server>

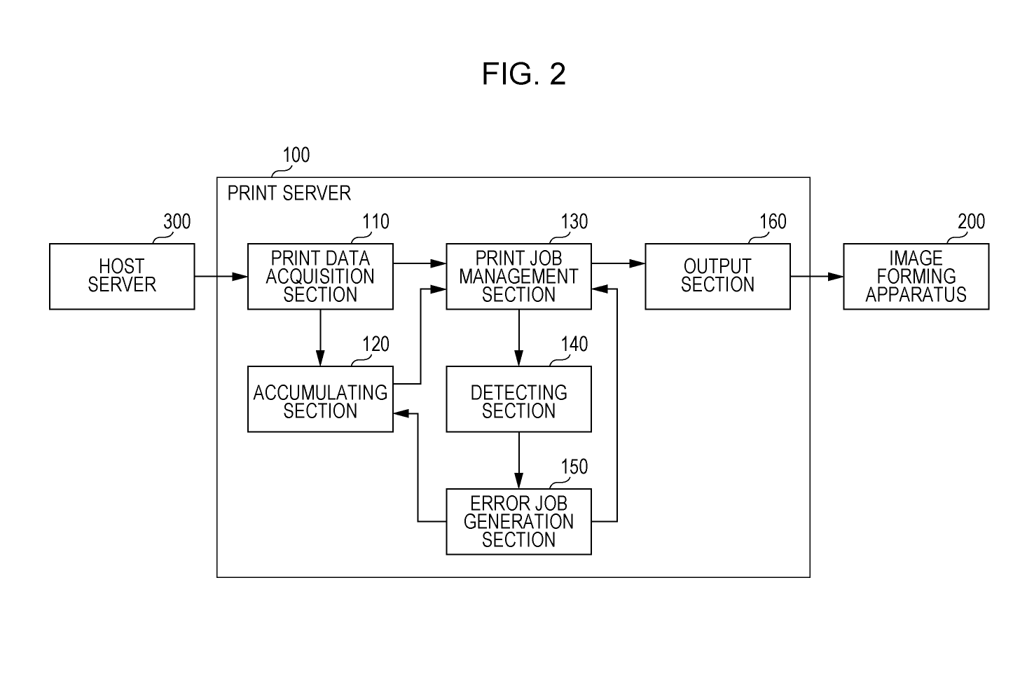

FIG. 2 illustrates an example of the functional configuration of the print server 100.

As illustrated in FIG. 2, the print server 100 according to the exemplary embodiment includes a print data acquisition section 110, an accumulating section 120, a print job management section 130, a detecting section 140, an error job generation section 150, and an output section 160. The print data acquisition section 110 is an example of an acquisition section that acquires print data for plural print jobs to be performed by the image forming apparatus 200. The accumulating section 120 temporarily accumulates the print data. The print job management section 130 manages the plural print jobs. The detecting section 140 detects the type of paper to be used for each of the plural print jobs on the basis of the print data. The error job generation section 150 generates an error job including information (data) that is not printable by the image forming apparatus 200. The output section 160 controls the image forming apparatus 200.

The print data acquisition section 110 acquires a print instruction and print data for each print job from the host server 300, converts the acquired print data into intermediate data, and accumulates the intermediate data in the accumulating section 120. The print data received from the host server 300 are written in a page description language (PDL). Therefore, the print data acquisition section 110 analyzes the received print data, and converts the print data into intermediate data that less depend on the model and the data processing environment. Then, the generated intermediate data are sent to the accumulating section 120.

The accumulating section 120 temporarily accumulates the print data, which have been converted into intermediate data by the print data acquisition section 110, for each print job. The print data are accumulated to absorb the difference between the speed of data processing performed by the print server 100 and the processing speed of the image forming apparatus 200 which physically forms an image on paper, the latter speed being lower. Thus, in the case where plural print instructions are provided in a short time, plural pieces of print data corresponding to such print instructions may be accumulated in the accumulating section 120. When the image forming apparatus 200 becomes able to receive print data, the accumulated pieces of print data are sequentially read and delivered to the print job management section 130 under management by the print job management section 130.

The print job management section 130 manages input and output of the print jobs. That is, the print job management section 130 manages the order in which the print jobs are executed and the time when printing is performed. Although discussed in detail later, the print job management section 130 also manages input and output of the error job generated by the error job generation section 150. Further, the print job management section 130 edits image data so as to conform to an output format adapted for the image forming apparatus 200.

The detecting section 140 acquires the paper name as the type of paper to be used for each of the plural print jobs. The configuration of the detecting section 140 will be discussed in detail later.

The error job generation section 150 generates an error job including data that is not printable by the image forming apparatus 200 when the detected paper type is different between successive print jobs as discussed in detail later.

The output section 160 is a so-called printer driver, and acquires the print data accumulated in the accumulating section 120 to sequentially output the print data to the image forming apparatus 200 if the image forming apparatus 200 is able to receive print data. As described above, in the case where plural print data are accumulated in the accumulating section 120, the accumulated print data are sequentially acquired and transmitted to the image forming apparatus 200 under management by the print job management section 130.

The output section 160 includes a language monitor and a port monitor, for example. The language monitor processes two-way communication between the accumulating section 120 and the image forming apparatus 200, for example, and delivers the print data to the port monitor. The port monitor transmits the delivered print data to the image forming apparatus 200.

<Example of Hardware Configuration>

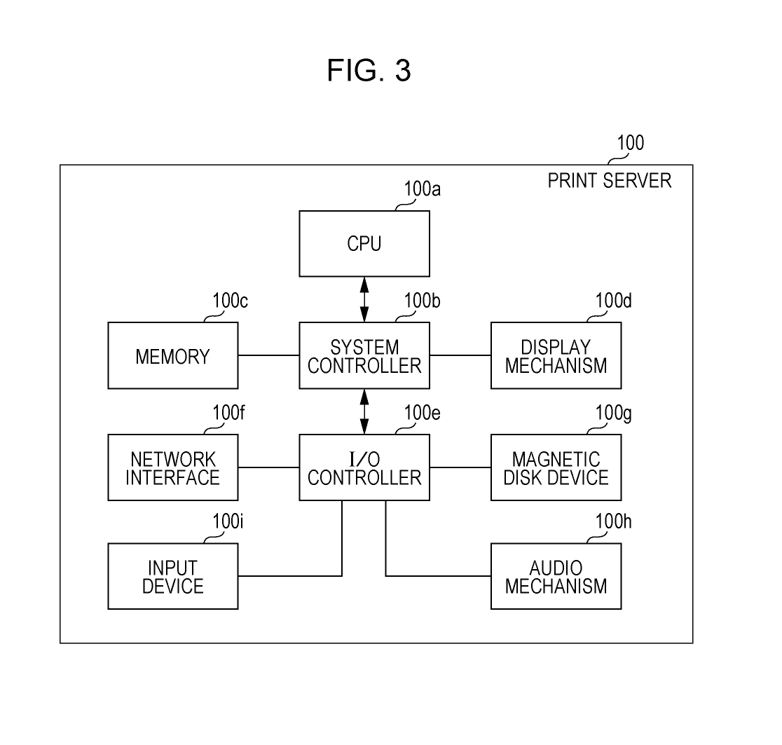

FIG. 3 illustrates an example of the hardware configuration of the print server 100.

FIG. 3 illustrates a computer that includes a central processing unit (CPU) 100a serving as a computation unit and a memory 100c serving as a storage unit. The computer also includes, as external devices, a magnetic disk device (hard disk drive (HDD)) 100g, a network interface 100f, a display mechanism 100d, an audio mechanism 100h, an input device 100i such as a keyboard and a mouse, and so forth.

In the configuration example illustrated in FIG. 3, the memory 100c and the display mechanism 100d are connected to the CPU 100a via a system controller 100b. In addition, the network interface 100f, the magnetic disk device 100g, the audio mechanism 100h, and the input device 100i are connected to the system controller 100b via an input/output (I/O) controller 100e. The constituent elements are connected to each other through various buses such as a system bus and an input/output bus.

In the print server 100 illustrated in FIG. 3, a program for implementing the functions of the print server 100 is stored in the magnetic disk device 100g. The various functions are implemented by loading the program into the memory 100c and causing the CPU 100a to execute processes on the basis of the program.

Specifically, the processes performed in the print data acquisition section 110, the print job management section 130, the detecting section 140, and the error job generation section 150 are performed by the CPU 100a on the basis of a program prepared as an application program, for example. The print instruction and the print data from the host server 300 are received via the network interface 100f, for example. The print data are converted by using the memory 100c as a working memory.

The accumulating section 120 is implemented by using a storage unit such as the memory 100c or the magnetic disk device 100g as a holding unit for the print data under control by the CPU 100a which executes a program module prepared as a part of the functions of an operating system (OS; basic software), for example.

The processes of the output section 160 are performed by the CPU 100a on the basis of a program module prepared as a part of the functions of the OS, for example.

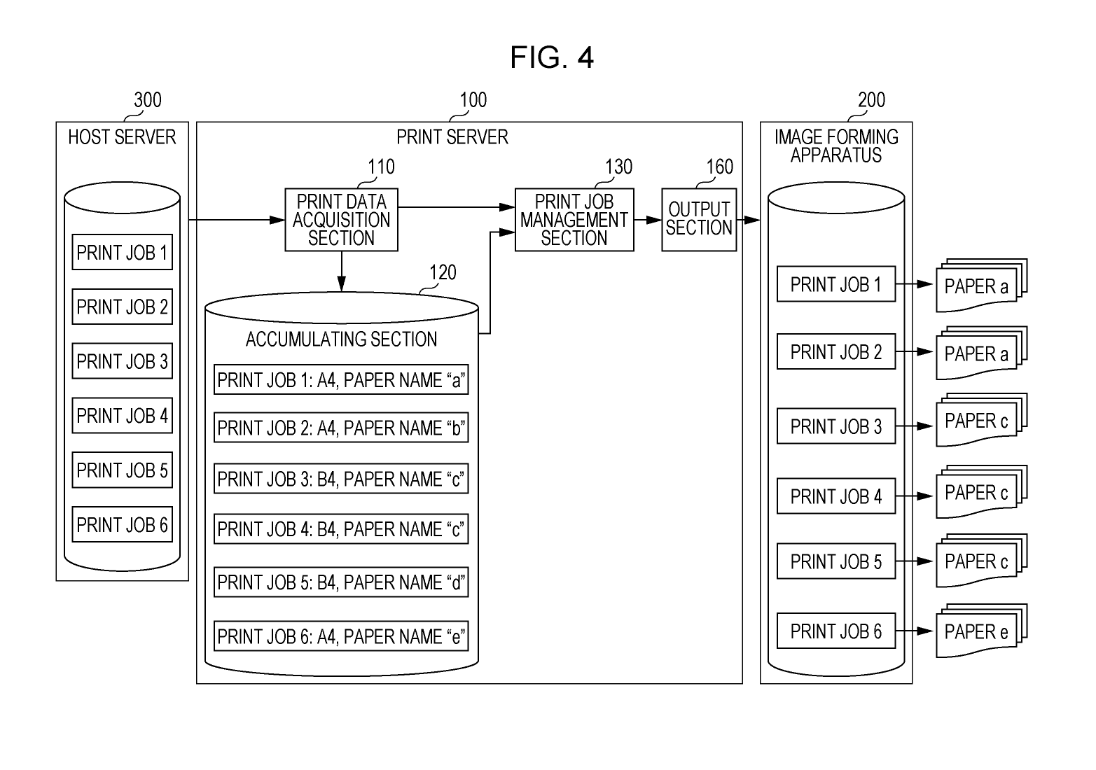

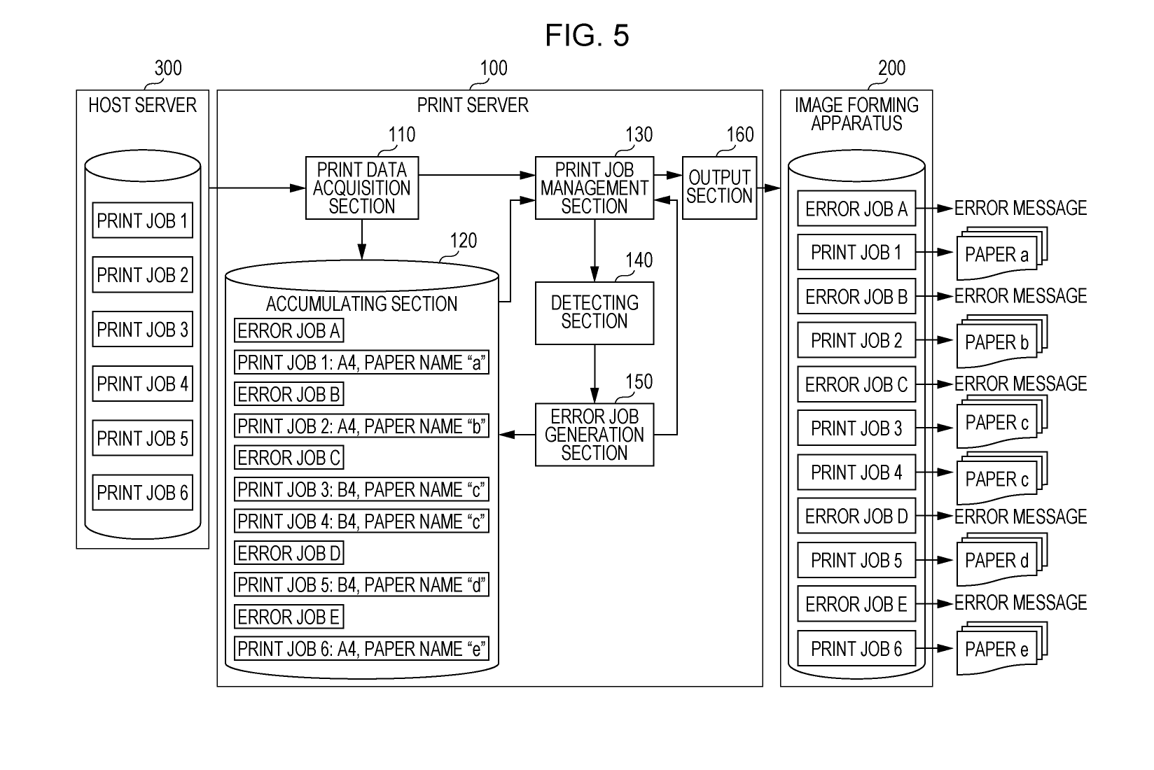

FIG. 5 illustrates an example of the functional configuration and operation of the print server 100 according to the exemplary embodiment, illustrated in accordance with FIG. 4.

Also in FIG. 5, print jobs 1 to 6 are acquired from the host server 300 and accumulated in the accumulating section 120, and further the print job management section 130 performs printing in this order. The paper sizes and the paper names of pieces of paper to be used for the print jobs 1 to 6 are the same as those for FIG. 4.

In this case, the detecting section 140 detects the paper name as the type of paper to be used for each of the print jobs 1 to 6. The detecting section 140 acquires the paper name “a” for the print job 1. Similarly, the detecting section 140 detects the paper names “b”, “c”, “c”, “d”, and “e” for the print jobs 2 to 6, respectively.

Then, the error job generation section 150 generates an error job (first error job) including data to be determined as an error by the image forming apparatus 200 when the detected paper type is different between successive print jobs. Specifically, different paper names indicate different paper types as discussed above, and therefore an error job B is prepared between the print job 1 and the print job 2. Similarly, an error job C, an error job D, and an error job E are prepared between the print job 2 and the print job 3, between the print job 4 and the print job 5, and between the print job 5 and the print job 6, respectively. No error job is prepared between the print job 3 and the print job 4 since the paper type is the same between the successive print jobs.

In the exemplary embodiment, in addition, an error job A is prepared also before the print job 1, because the paper name of the paper prepared when the print job 1 is to be performed is not necessarily “a”. That is, the error job generation section 150 further generates an error job A which is an error job (second error job) to be performed further before the first one, namely the print job 1, of the plural print jobs 1 to 6.

In the exemplary embodiment, the error jobs A to E are accumulated in the accumulating section 120. Then, the print job management section 130 manages execution of the print jobs such that the print jobs 1 to 6 and the error jobs A to E are arranged in the order discussed above. That is, when the error jobs are generated, the error jobs are inserted between the successive print jobs, and further the error job A is disposed further before the first print job, namely the print job 1. Specifically, the print jobs and the error jobs are executed in the order of the error job A, the print job 1, the error job B, the print job 2, the error job C, the print job 3, the print job 4, the error job D, the print job 5, the error job E, and the print job 6.

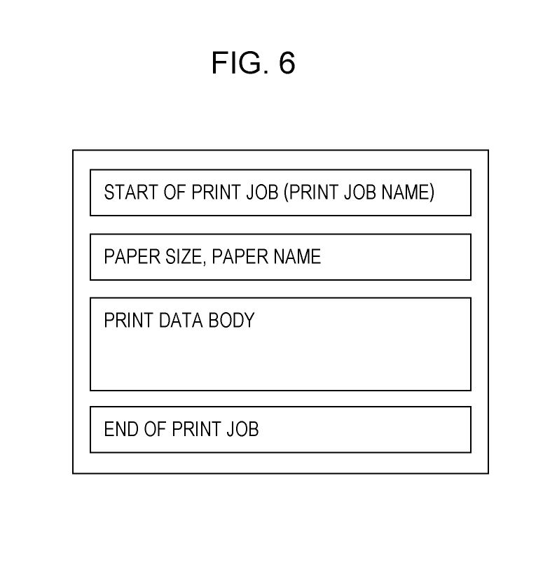

FIG. 6 illustrates the data format of print data for the print jobs and the error jobs.

In the exemplary embodiment, the contents of print data for the print jobs and the error jobs have the same format. As illustrated in FIG. 6, the print data for the print jobs (error jobs) are composed of data on the print job name indicating the start of the print job (error job), data on the paper size and the paper name, a print data body that is data for forming an image on paper, and data indicating the end of the print job (error job), arranged in this order.

For the print jobs, such data have a printable content. For the error jobs, however, at least one of the data contains data determined as an error by the image forming apparatus 200. Some examples of the data determined as an error by the image forming apparatus 200 have a paper size that does not allow printing by the image forming apparatus 200. Specifically, the data may have a paper size with a height of 1000 inches and a width of 1000 inches, for example.

Alternatively, the print data body may be prepared so as to contain no printable data. For example, the print data body may contain data with only control codes, or only invalid character codes. Specifically, the entire print data body may contain NULL codes (data of “0x00”), for example.

When such error jobs are prepared, the image forming apparatus 200 is unable to execute the error jobs even if it attempts to, and therefore stops printing and outputs an error message.

It is desirable that the print job name of the error jobs should be “Change to paper ‘(paper name)’”. The paper name of the paper to be used in the next job may be placed in “(paper name)”. Such a configuration makes the error message more understandable as discussed in detail later.

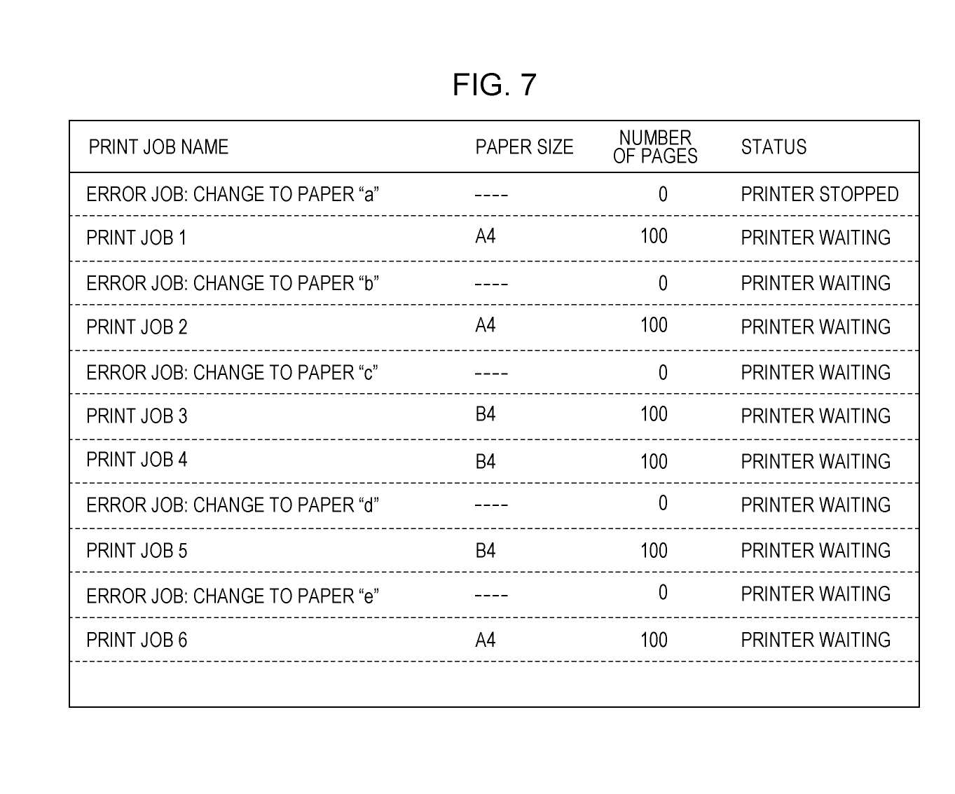

FIG. 7 illustrates a first example of the error messages output from the image forming apparatus 200.

In the illustrated example, when the image forming apparatus 200 outputs error messages, messages including the error messages are displayed on a display section, such as a touch panel, provided to the image forming apparatus 200. The display section displays plural messages for print jobs accumulated in the image forming apparatus 200 to be performed.

As illustrated in FIG. 7, the display items include “Print job name”, “Paper size”, “Number of pages”, and “Status”, which are arranged in this order from the left in FIG. 7. Messages corresponding to the above items are collectively displayed for each of the print jobs 1 to 6 and the error jobs A to E.

In the illustrated example, an error message corresponding to the error job A and indicating that the print job name is “Error job: Change to paper ‘a’” is displayed in the row below the above items. The portion “Change to paper ‘a’” corresponds to the print job name of the error job A discussed above. The portion “(paper name)” corresponds to “a” which is the name of the paper to be used in the next print job, namely the print job 1. In this case, when the print job name of the error job is determined in this way, the message that prompts a change of paper may be displayed to the user in a more understandable manner. In the “Status”, “Printer stopped” is displayed for the error job A. In the “Paper size”, no display is made because the error job A is not executable. In the “Number of pages”, “0” is displayed for the same reason.

In the next row, a message corresponding to the print job 1 is displayed. That is, “Print job 1” is displayed as the print job name of the next print job, “A4” is displayed as the paper size, and “100” is displayed as the number of pages. In the “Status”, “Printer waiting” is displayed for the print job 1.

Similarly, messages including error messages are displayed for the print jobs 2 to 6 and the error jobs B to E in the order of execution.

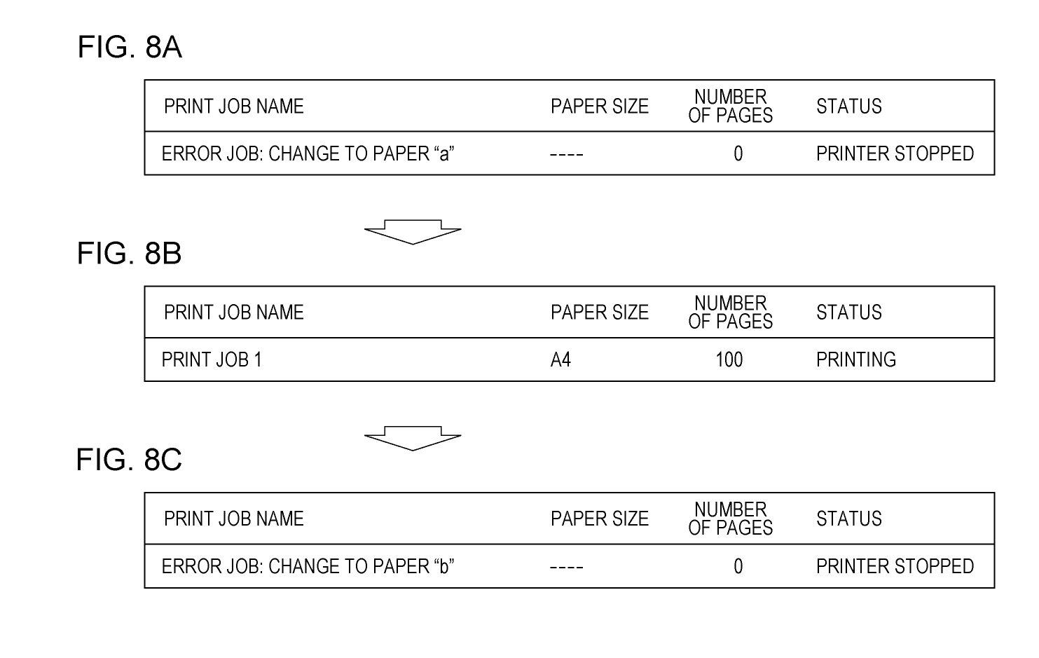

FIGS. 8A to 8C illustrate a second example of the error messages output from the image forming apparatus 200.

In the illustrated example, a message including an error message is displayed for the print job or the error job currently being executed.

In FIG. 8A, an error message for the error job A is displayed as the first message to be displayed on the display section of the image forming apparatus 200.

The image forming apparatus 200 first attempts to execute the error job A. Since the error job A is an error job, however, the image forming apparatus 200 is unable to perform printing, and stopped. Then, the same error message as in FIG. 7 is displayed on the display section. In this event, “Error job: Change to paper ‘a’” is displayed as the print job name, and therefore the user is prompted to change paper to paper “a”.

Then, the user changes paper, and further performs an operation of stopping and canceling execution of the error job A. This allows the image forming apparatus 200 to proceed to a process of performing the next print job 1.

Since the print job 1 is executable, printing for the print job 1 is started. In this event, the message indicated in FIG. 8B is displayed on the display section of the image forming apparatus 200.

The message is a message for the print job 1 being performed. That is, “Print job 1” is displayed as the print job name of the print job currently being executed, “A4” is displayed as the paper size, and “100” is displayed as the number of pages. In the “Status”, “Printing” is displayed.

When printing for the print job 1 is finished, the image forming apparatus 200 attempts to execute the error job B. Since the error job B is an error job, however, the image forming apparatus 200 is unable to perform printing, and stopped again.

Then, the message indicated in FIG. 8C is displayed on the display section of the image forming apparatus 200. That is, “Error job: Change to paper ‘b’” is displayed as the print job name. In the “Status”, “Printer stopped” is displayed for the error job B. In the “Paper size”, further, no display is made because the error job B is not executable. In the “Number of pages”, “0” is displayed for the same reason.

Then, the user changes paper, and further performs an operation of stopping and canceling execution of the error job B. This allows the image forming apparatus 200 to proceed to a process of performing the next print job 2.

In this way, the image forming apparatus 200 performs processes for the print jobs 2 to 6 and the error jobs C to E in the order of execution. During the print jobs, the image forming apparatus 200 performs printing, and the display section displays a message such as that in FIG. 8B. During the error jobs, meanwhile, the image forming apparatus 200 is stopped, and the display section displays an error message such as those in FIGS. 8A and 8C.

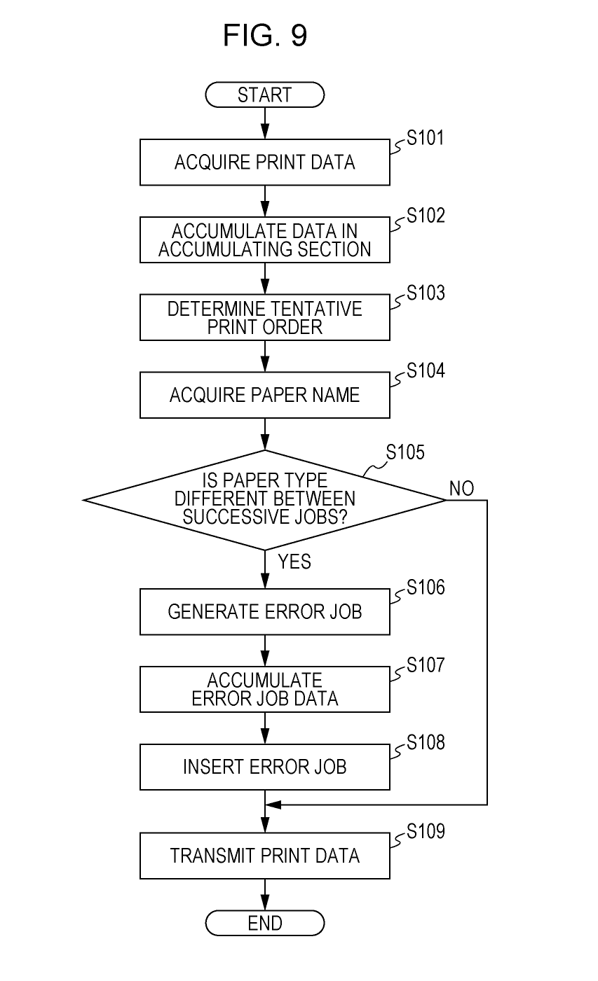

FIG. 9 is a flowchart illustrating operation of the print server 100.

First, the print data acquisition section 110 acquires print data etc. for each print job from the host server 300 (step S101).

Then, the print data acquisition section 110 converts the acquired print data etc. into intermediate data, and accumulates the data for each print job in the accumulating section 120 (step S102).

Next, the print job management section 130 determines a tentative print order for the print jobs accumulated in the accumulating section 120 (step S103).

Meanwhile, the detecting section 140 acquires the paper name as the type of paper to be used for each print job (step S104).

Next, the error job generation section 150 references the tentative print order determined in step S103, and determines whether or not the detected paper type is different between successive print jobs (step S105). In this event, the paper type is determined in accordance with the paper name.

Then, in the case where the detected paper type is different between successive print jobs (Yes in step S105), the error job generation section 150 generates an error job (step S106).

Print data for the generated error job are accumulated in the accumulating section 120 (step S107).

Then, the print job management section 130 inserts the error job between the successive print jobs (step S108). Consequently, the final print order is determined.

On the other hand, in the case where the detected paper type is all the same between successive print jobs (No in step S105), an error job is not generated, and the process proceeds to step S109. For the print order, the tentative print order determined in step S103 is used as it is as the final print order.

Further, the output section 160 transmits the print data etc. to the image forming apparatus 200 in accordance with the final print order (step S109). In this event, as described in relation to FIG. 6, the output section 160 outputs to the image forming apparatus 200 a print job name of an error job including information about paper to be used in the print job that follows the error job.

In the exemplary embodiment, as discussed in detail above, in the case where the paper type is different between print jobs that are executed successively, an error job is inserted between the print jobs. Consequently, in the image forming apparatus 200, printing is stopped and an error message that prompts a change of paper is displayed because of the error job.

In the case discussed in detail above, one host server 300 is provided in order to facilitate description. However, plural host servers 300 may be provided. Also, although one image forming apparatus 200 is provided in the case described above, plural image forming apparatuses 200 may be provided. Further, plural print servers 100 may be provided, and the print servers 100 may each be configured as discussed above.

In the example discussed above, the paper type is determined in accordance with the paper name. However, the present invention is not limited thereto, and the paper type may be determined in accordance with the number or the like provided to the paper, for example.

<Program>

As described in relation to FIG. 3, the processes performed by the print server 100 according to the exemplary embodiment described above are prepared by an application program, for example.

Hence, the process performed by the print server 100 may be considered as a program causing a computer to execute a process including: acquiring print information on plural print jobs to be performed by an image forming apparatus 200; detecting types of recording materials to be used in units of the plural print jobs on the basis of the acquired print information; generating a first error job including information that is not printable by the image forming apparatus when the detected types of the recording materials are different between successive print jobs; and managing the plural print jobs and inserting the first error job between the successive print jobs when the first error job is generated.

The programs for implementing the exemplary embodiment may be not only provided by a communication unit but also provided as stored in a recording medium such as a CD-ROM.

While an exemplary embodiment of the present invention has been described above, the technical scope of the present invention is not limited to the exemplary embodiment described above. It is apparent from the following claims that a variety of modifications and improvements that may be made to the exemplary embodiment described above also fall within the technical scope of the present invention.

What is claimed is:

1. A print management apparatus comprising:
an acquisition section that acquires print information on a plurality of print jobs to be performed by an image forming apparatus;
a detecting section that detects types of recording materials to be used in units of the plurality of print jobs on a basis of the acquired print information;
an error job generation section that generates a first error job including information that is not printable by the image forming apparatus when the detected types of the recording materials are different between successive print jobs; and
a print job management section that manages the plurality of print jobs and that inserts the first error job between the successive print jobs when the first error job is generated.

2. The print management apparatus according to claim 1,
wherein the error job generation section further generates a second error job to be performed further before a first one of the plurality of print jobs.

3. The print management apparatus according to claim 2, further comprising:
an output section that sequentially outputs pieces of the print information to the image forming apparatus,
wherein the output section outputs to the image forming apparatus a job name of the first error job and the second error job including information about one recording material to be used in one print job that follows the first error job or the second error job.

4. The print management apparatus according to claim 1,
wherein the error job generation section determines the type of the recording material in accordance with a paper name.

5. An image forming system comprising:
an image forming apparatus that performs printing by forming an image on a recording material; and
a print management apparatus that manages the printing performed by the image forming apparatus,
wherein the print management apparatus includes
an acquisition section that acquires print information on a plurality of print jobs to be performed by the image forming apparatus;
a detecting section that detects types of recording materials to be used in units of the plurality of print jobs on a basis of the acquired print information;
an error job generation section that generates a first error job including information that is not printable by the image forming apparatus when the detected types of the recording materials are different between successive print jobs; and
a print job management section that manages the plurality of print jobs and that inserts the first error job between the successive print jobs when the first error job is generated.

6. A non-transitory computer readable medium storing a program causing a computer to execute a process comprising:
acquiring print information on a plurality of print jobs to be performed by an image forming apparatus;
detecting types of recording materials to be used in units of the plurality of print jobs on a basis of the acquired print information;
generating a first error job including information that is not printable by the image forming apparatus when the detected types of the recording materials are different between successive print jobs; and
managing the plurality of print jobs and inserting the first error job between the successive print jobs when the first error job is generated.
